(19) United States
(12) Patent Application Publication
(10) Pub. No.: US 2026/0238366 A1
(43) Pub. Date: Aug. 13, 2026

(54) RING SEARCH METHOD FOR GEOLOCATION ENHANCEMENTS

(71) Applicant: NetScout Systems, Inc., Westford, MA (US)

(72) Inventors: Imran Hafeez, Allen, TX (US); Le Yang, Livermore, CA (US); Oguz Dogan, Chicago, IL (US); Michael Wright, Bethesda, MA (US); Yahya Idrissi, Allen, TX (US)

(73) Assignee: NetScout Systems, Inc., Westford, MA (US)

(21) Appl. No.: 19/531,945

(22) Filed: Feb. 6, 2026

Related U.S. Application Data
(60) Provisional application No. 63/755,849, filed on Feb. 7, 2025.

(51) Int. Cl. H04B 17/391; H04W 4/021; H04W 16/18

(52) U.S. Cl. CPC H04B 17/3913; H04W 4/021; H04W 16/18

(57) ABSTRACT

A system can obtain candidate geolocations of a mobile device participating in a communications session with a computing device over a communications network. The system can calculate a predicted reference signal received power (RSRP) for each candidate geolocation based on signal propagation characteristics, calculate a penalty for each candidate geolocation as a function of the predicted RSRP, and identify a first candidate geolocation associated with a lowest penalty. The system can generate a left arc length and a right arc length from the first candidate geolocation based on candidate geolocations corresponding with penalties greater than or equal to the lowest penalty plus a variation threshold. The system can calculate an accuracy as a function of the left arc length and the right arc length, and store, responsive to determining the accuracy exceeds a threshold, an association between the first candidate geolocation and the mobile device.

### CROSS-REFERENCE TO RELATED APPLICATIONS

This application claims the benefit of priority to U.S. Provisional Patent Application No. 63/755,849 filed Feb. 7, 2025, the entirety of which is incorporated by reference herein.

### BACKGROUND

Cell towers continuously process high volumes of data streams, capturing network events from connected user equipment (UE). Indicators such as Timing Advance (TA) are utilized in cellular networks to manage and interpret network events and can be used in determining geolocations of UE by estimating the distance between UE and base stations. Processing these indicators in real-time for a large number of users can require significant computing resources, especially in dense urban environments or during peak usage periods.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for performing geolocation processing using a ring search method, in accordance with an implementation;

FIG. 2 is an example method for performing geolocation processing using a ring search method, in accordance with an implementation;

FIG. 3 is an example method for performing geolocation processing using a ring search method, in accordance with an implementation;

FIG. 4 is an illustration of an example penalty function, in accordance with an implementation;

FIG. 5 is an illustration of an example system for performing a relative signal metric (RSM) geolocation algorithm, in accordance with an implementation;

FIG. 6A is a block diagram depicting an implementation of a network environment including a client device in communication with a server device;

FIG. 6B is a block diagram depicting a cloud computing environment including a client device in communication with cloud service providers; and

FIG. 6C is a block diagram depicting an implementation of a computing device that can be used in connection with the systems depicted in FIGS. 1, 5, 6A, and 6B and the methods depicted in FIGS. 2 and 3.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

This disclosure relates to systems and methods for locating user equipment (UE), such as through a ring search method for geolocation enhancements. Some systems can perform accurate geolocation processing at extremely slow processing speeds, making them inefficient for real-time applications. Handling a high volume of calls from cells can be resource-intensive due to the need for substantial processing power, memory, and network resources. Resource-intensive applications, such as those used for geolocation, can cause system slowdowns, battery drain, and even crashes. Managing calls from multiple cells requires careful optimization and resource management to maintain system stability and to generate accurate results.

A computer implementing the systems and methods described herein can overcome the aforementioned technical deficiencies. The computer can do so using flag generators such as a movement flag generator which assigns a movement flag based on signal data. For example, the computer can receive and store, from a plurality of cells, signal data for a communications session between a mobile device and computing device occurring over a communications network, the signal data including a plurality of sets of signal data each generated at a different time. In doing so, a geolocation time series generator can determine a timeseries of geolocations of the UE during the communications session based on the plurality of sets of signal data received for the communications session from the plurality of cells.

Subsequently, the computer can determine a current speed of the UE based on the timeseries of geolocations of the UE. The computer can determine a final speed by adjusting the current speed based on a previously determined speed of the UE. The adjustment can involve determining an average speed based on the current speed and the final speed, such as by determining a weighted average speed based on the current speed and the final speed. The computer can determine the weighted average speed by determining a weight of the weighted average speed as a function of a length of time between the current speed and the previously determined speed. Responsive to determining the final speed exceeds a threshold, the movement flag generator can generate a flag in memory indicating movement of the UE. A network configuration tool can configure the communications network based on the flag indicating movement of the UE.

The computer can generate a second flag in memory indicating an environment of the UE based on the first flag in memory indicating movement of the UE and an amount of time. The computer can determine an indoor or outdoor classification of the UE based at least on a Reference Signal Received Power (RSRP) measured by the UE. In general, signal strength increases as distance between a user and a cell decreases. Accordingly, the computer can generate, as output, a geolocation of the UE based at least on the flag indicating movement, the second flag indicating an environment, and the indoor or outdoor classification.

In some cases, the computer can obtain a plurality of candidate geolocations of a UE participating in a communications session with a computing device over a communications network, the plurality of candidate geolocations located in a ring around a cell of the communications network. The computer can calculate a predicted RSRP for each of the plurality of candidate geolocations based on a plurality of signal propagation characteristics associated with each of the plurality of candidate geolocations, as described further herein. The computer can calculate a penalty for each of the plurality of candidate geolocations as a function of the predicted RSRP calculated for the candidate geolocation. Subsequently, the computer can identify a first candidate geolocation that is associated with a lowest penalty of the plurality of candidate geolocations and generate a left arc length of the ring from the first candidate geolocation to a second candidate geolocation. The computer can select the second candidate location from a first sequence of the plurality of candidate geolocations to the left of the first candidate geolocation based on the second candidate geolocation corresponding with a first penalty greater than or equal to the lowest penalty plus a variation threshold. The system can generate a right arc length of the ring from the first candidate geolocation to a third candidate geolocation. The computer can select the third candidate geolocation from a second sequence of the plurality of candidate geolocations to the right of the first candidate geolocation based on the third candidate geolocation corresponding with a second penalty greater than or equal to the lowest plus the variation threshold. The computer can calculate an accuracy of the first candidate geolocation as a function of the left arc length and the right arc length. Responsive to determining the accuracy exceeds a threshold, the computer can store an association between the first candidate geolocation and the UE in memory. The computer can generate the left arc length by iteratively comparing penalties of the first sequence of the plurality of candidate geolocations to sum of the lowest penalty and the variation threshold moving to the left of the first candidate geolocation around the ring. The computer can generate the right arc length by iteratively comparing penalties of the first sequence of the plurality of candidate geolocations to sum of the lowest penalty and the variation threshold moving to the right of the first candidate geolocation around the ring.

The computer can determine a predicted RSRP for each of the plurality of candidate geolocations based on a plurality of signal propagation characteristics associated with each of the plurality of candidate geolocations. The computer can determine a predicted RSRP at a given point using a propagation model. For example, a Hata model can be used, which does not account for terrain or clutter, making the predicted path loss from a transmitter a function of distance. Future implementations could incorporate more complex path loss models that consider terrain and clutter. The Hata model is expressed as:

$$predictedPathLoss = {A}_{1} + {A}_{2} log ( f ) + {A}_{3} log ( {H}_{Tx} ) + ( {B}_{1} + {B}_{2} log ( {H}_{Tx} ) ) * log ( d )$$

where H_{Tx} is the transmitter height in meters, f is the frequency in MHz, and d is the distance in meters. All logarithms are base 10, and the predicted path loss is in decibels (dB). The predicted RSRP is then calculated using the formula:

$$predictedRsrp = Tx power + antennaMaxGain - txLoss - antennaDiscrimiation - predictedPathLoss$$

where the predicted RSRP and Tx power are in decibel-milliwatts (dBm), and all other terms are in dB. The antennaMaxGain and txLoss values are found in a network element table of the network 105 stored in memory. The antennaDiscrimination is a function of the angle from the boresight (e.g., the optical axis of a directional antenna, the direction in which the antenna has maximum gain) and is given by:

$$antennaDiscrimiation = 3 * {( \frac{θ}{{θ}_{beamwidth}} )}^{2}$$

where θ is the azimuth relative to the boresight, and θ_{beamwidth} is the horizontal beamwidth of the individual beams produced by the antenna.

In some cases, the computer can determine a penalty range of the ring based on the calculated penalties for the plurality of candidate geolocations. The computer can determine a variation threshold based at least on the penalty range and adjust the accuracy to a final accuracy based on a number of RSRP predictors. The computer can compare the accuracies to a plurality of thresholds to determine a confidence for the first candidate geolocation. Responsive to determining that the confidence is high, the computer can store the association between the first candidate geolocation and the UE in memory.

Accordingly, the computer can adjust the communications network based on the stored association between the first candidate geolocation and the UE, such as by moving antennas into an optimal position based on the stored results. By implementing the systems and methods described herein, the computer can enhance the efficiency of generating geolocation results in real-time applications, thereby optimizing resource management and maintaining system stability. By optimizing resource management and maintaining system stability, these systems and methods generate accurate geolocation results in real-time applications. For example, the system can obtain a geolocation event associated with a UE, determine the speed and movement classification of the UE, and generate a geolocation based on various classifications. In addition, the system can determine penalties associated with geolocations organized in a geolocation data configuration ring, calculate accuracy based on arclengths, and generate a confidence level for the estimated geolocation.

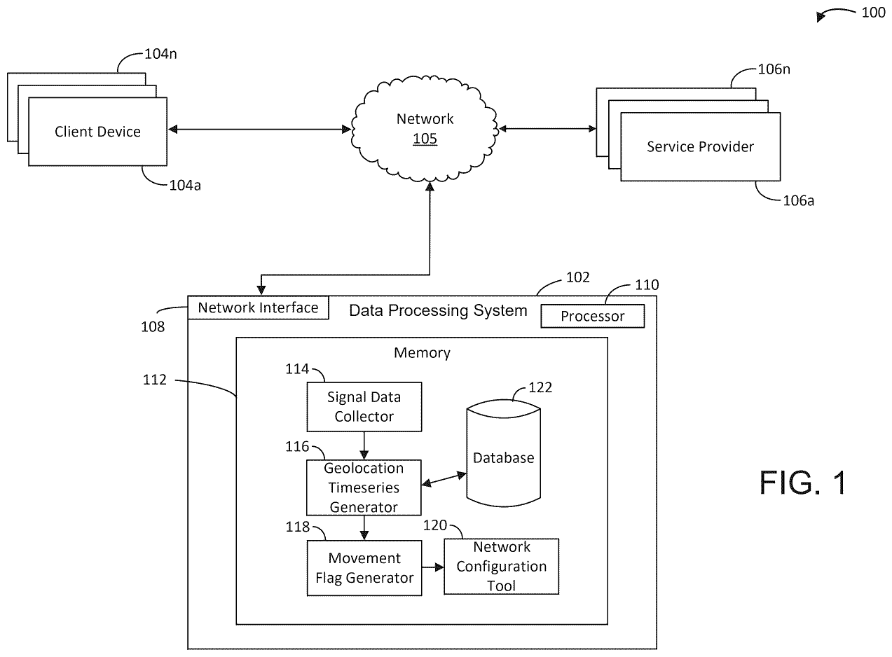

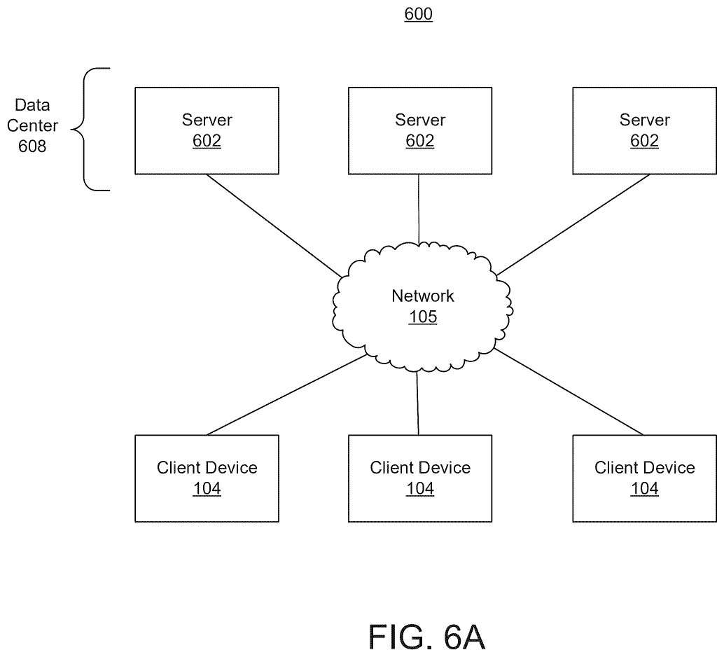

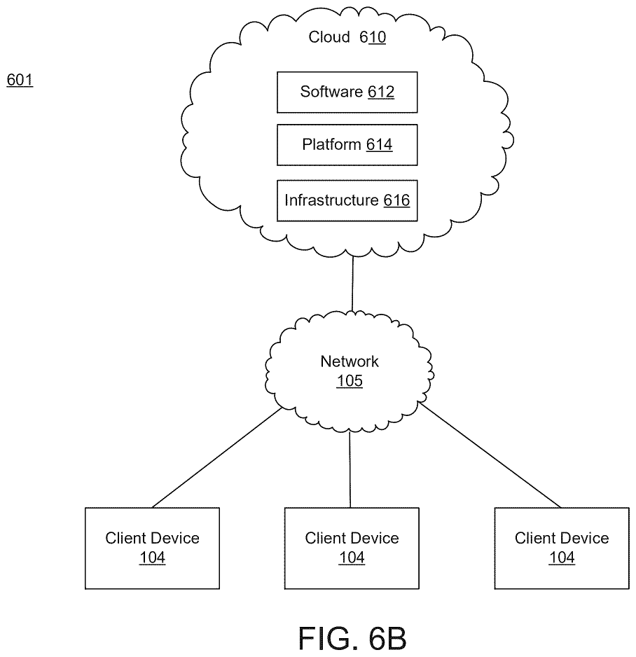

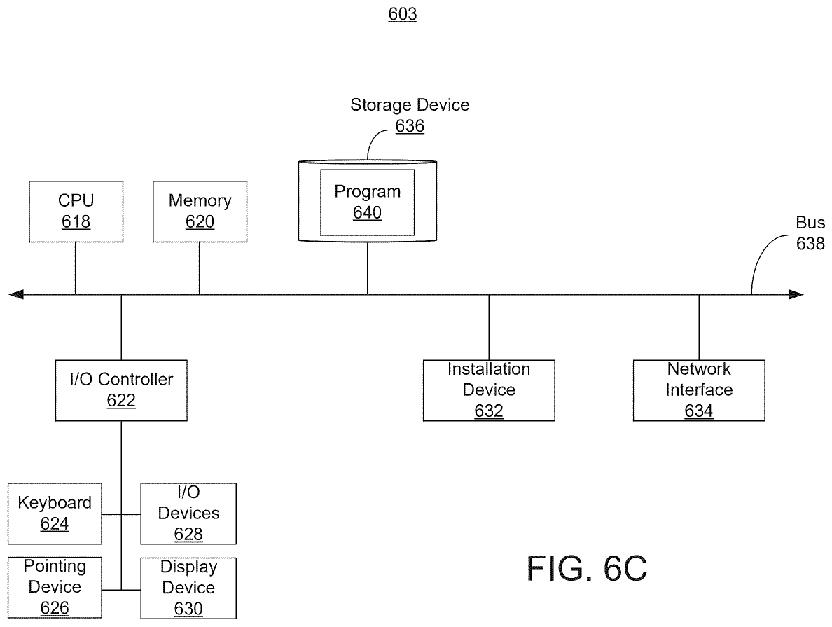

FIG. 1 illustrates an example system 100 for performing geolocation processing using a ring search method, in some embodiments. In brief overview, the system 100 can include a data processing system 102 that receives and/or stores signal data transmitted via a network 105 between client devices 104a-n (hereinafter client device 104 or client devices 104) and service providers 106a-n (hereinafter service provider 106 or service providers 106). The system 100 may provide improved network processing of a communications network to efficiently locate user equipment (UE), such as client device 104. The client device 104 may be a mobile device. The service providers 106 can each include a set of one or more servers 602, depicted in FIG. 6A, or a data center 608. The service providers 106 may be associated with or be one or more cells or cell towers such as a base station. The data processing system 102 can generate a database or data structure by storing session information for different communication sessions in the database, storing the session information for different communication sessions in different records in the database. A geolocation timeseries generator 116 can subsequently determine a timeseries of geolocations of client device 104 during the communications session based on the plurality of sets of signal data received for the communications session from the plurality of cells.

The data processing system 102, the client devices 104, and/or the service providers 106 can each include or execute on one or more processors or computing devices (e.g., the computing device 603 depicted in FIG. 6C) and/or communicate via the network 105. The network 105 can be a communications network and can include computer networks such as the Internet, local, wide, metro, or other area networks, intranets, satellite networks, and other communication networks such as voice or data mobile telephone networks. The network 105 can be used to access information resources such as web pages, websites, domain names, or uniform resource locators that can be presented, output, rendered, or displayed on at least one computing device (e.g., client device 104), such as a laptop, desktop, tablet, personal digital assistant, smartphone, portable computers, or speaker. In some embodiments, the network 105 may be or include a self-organizing network that implements a machine learning model to automatically adjust connections and configurations of network elements of the network 105 to optimize network connections (e.g., minimize latency, reduce dropped calls, increase data rate, increase quality of service, etc.). The network elements of the network 105 may include one or more antennas and one or more transmitters.

Each of the data processing system 102, the client devices 104, and/or the service providers 106 can include or utilize at least one processing unit or other logic device such as a programmable logic array engine, or module configured to communicate with one another or other resources or databases. The components of the data processing system 102, the client devices 104, and/or the service providers 106 can be separate components or a single component. The system 100 and its components can include hardware elements, such as one or more processors, logic devices, or circuits.

As used herein, the term “geolocation” may refer to the process of identifying the physical location of a device or UE based on available network information, which can include control plane data and other signal data. The term “geolocation” may also be used to describe the location or the estimated location of the device or UE. In the context of the systems and methods described herein, “geolocation” and “location” can be used interchangeably, as both terms refer to the determination of a device's or user's physical position.

Still referring to FIG. 1, and in further detail, the system 100 can include the service providers 106. The service providers 106 may each be or include servers or computers configured to transmit or provide services across network 105 to the client devices 104. The service provider 106 can be or include host computing devices. The service providers 106 may transmit or provide such services upon receiving requests for the services from any of the client devices 104. The term “service” as used herein includes the supplying or providing of information over a network and is also referred to as a communications network service. Examples of services include 5G broadband services, any voice, data, or video service provided over a network, smart-grid network, digital telephone service, cellular service, Internet protocol television (IPTV), etc.

A client device 104 can be located or deployed at any geographic location in the network environment depicted in FIG. 1. A client device 104 can be deployed, for example, at a geographic location where a typical user using the client device 104 would seek to connect to a network (e.g., access a browser or another application that requires communication across a network). For example, a user can use a client device 104 to access the Internet at home, as a passenger in a car, while riding a bus, in the park, at work, while eating at a restaurant, or in any other environment. The client device 104 can be deployed at a separate site, such as an availability zone managed by a public cloud provider (e.g., a cloud 610 depicted in FIG. 6B). If the client device 104 is deployed in a cloud 610, the client device 104 can include or be referred to as a virtual client device or virtual machine. In the event the client device 104 is deployed in a cloud 610, the packets exchanged between the client device 104 and the service providers 106 can still be retrieved by network monitoring equipment or the data processing system 102 from the network 105. In some cases, the data processing system 102 and/or the client devices 104 can be deployed in the cloud 610 on the same computing host in an infrastructure 616 (described below with respect to FIG. 6B).

The data processing system 102 may comprise one or more processors that are configured to receive signal data between the client devices 104 and/or the service providers 106 across the network 105. The data processing system 102 may comprise a network interface 108, a processor 110, and/or memory 112. The data processing system 102 may communicate with network monitoring equipment, in some embodiments. The processor 110 may be or include an ASIC, one or more FPGAs, a DSP, circuits containing one or more processing components, circuitry for supporting a microprocessor, a group of processing components, or other suitable electronic processing components. In some embodiments, the processor 110 may execute computer code or modules (e.g., executable code, object code, source code, script code, machine code, etc.) stored in the memory 112 to facilitate the operations described herein. The memory 112 may be any volatile or non-volatile computer-readable storage medium capable of storing data or computer code.

The memory 112 can store a signal data collector 114, a geolocation timeseries generator 116, a movement flag generator 118, a network configuration tool 120, and/or a database 122. The components 114-122 can operate to collect, process, and flag signal data for configuring the communications network. The signal data collector 114 can receive signal data associated with client device 104. The geolocation timeseries generator 116 can determine a timeseries of geolocations of the client device 104 based on the signal data. The components 114-122 can determine a current speed of the client device 104 by determining a difference between a current location and a previous location of client device 104, then dividing the difference by the time elapsed between a timestamp of client device 104 associated with the previous location to a timestamp of client device 104 associated with the current location. In some cases, components 114-122 can adjust the current location by applying a timing advance (TA) quantization and a radial quantization, considering both the timing of the signal data and radial distance of the current location from a base station The previous location and a time associated with the previous location may be obtained from metadata associated with stored signal data in the database 122. The previous location may have been a previously determined location, determined using the systems and methods described herein. In some cases, the components 114-122 can adjust the current speed to a final speed based on a previously determined speed of the client device 104. The previously determined speed may be obtained from metadata associated with stored signal data in the database 122. The final estimation of speed may be determined by generating a weighted averaging of the current speed of the client device 104 and a previous speed of the client device 104. In some cases, a weight associated with the previous speed decreases with time exponentially. The components 114-122 determine the current speed of client device 104 in minimum time intervals of three seconds. In response to the minimum time interval not being reached, the previous speed can be used as the final current speed. The stored signal data is considered in determining whether the client device 104 is classified as mobile or stationary. The components 114-122 can generate a flag in memory indicating movement of the client device 104 based at least on the final speed. For each geolocation event associated with the signal data (e.g., a call start, call end, or fragment end) of client device 104, a flag in memory indicating movement of the client device 104 is assigned. The final speed for each event is compared with a speed threshold, which defaults to 1.5 meters per second. If the speed exceeds this threshold, the components 114-122 set the flag in memory indicating movement of client device 104 to True; otherwise, it is set to False. In this way, the components 114-122 can configure the communications network based on the flag indicating movement of the client device 104.

In some cases, the components 114-122 can generate an indoor or outdoor classification using an indoor determinator. The indoor/outdoor classification process begins by prioritizing the assignment of a call to “indoor” if it has been served by an indoor cell since the previous location's end time. Each location has a start and end time, which can be the same for moving events but can span a long time for stationary events. If an event has been served by an indoor cell, it is assigned to “indoor” regardless of its flag in memory indicating movement of client device 104. Responsive to one or more of the stationary events not having been served by an indoor cell, the classification proceeds to the next steps. For stationary events with Timing Advance (TA), the classification involves calculating a reasonable range of RSRP values, from a minimum RSPRP to a maximum RSRP. The minimum RSRP is the expected RSRP, given a distance equal to the TA and an angle of 90 degrees from the boresight of the base station or cell. The maximum RSRP is the expected RSRP, given a distance equal to the TA and an angle on the boresight. An average RSRP is then calculated for the time range between the previous location's end time and the request time. If the average RSRP falls significantly below this range, the event is assigned to “indoor.” For stationary events without TA, the average RSRP is compared against a constant threshold to determine whether the event should be classified as “indoor” or “outdoor.”

In some cases, the components 114-122 can generate an environment flag. The assignment of the environment flag can be performed downstream by the geolocation algorithms in the indoor determinator. Each event has one environment flag, but only the environment flag for the call end is displayed. Responsive to client device 104 not being stationary and the timestamp being close to the end time of the previous location, the environment is determined to be “mobile”. Responsive to client device 104 remaining stationary and the last environment not being available, and either the time elapsed since the last call is short or there are no RSRP events, the environment is set to the last known environment in order to prevent rapid changes between indoor and outdoor stationary states. In some cases, the environment is determined based on RSRP values using the indoor determinator.

Accordingly, the components 114-122 can generate, as output, a geolocation of the client device 104 based at least on the flag indicating movement, the environment flag, and the indoor or outdoor classification.

The components 114-122 can generate a confidence and accuracy estimation associated with the geolocation of the outputted geolocation based on a penalty variation across the Timing Advance (TA) ring, where a penalty value is assigned to discrete points for each geolocation. The components 114-122 can determine the penalty range for the entire ring by determining a difference between the maximum and minimum penalties. The components 114-122 can then heuristically define a variation threshold as a fraction (e.g., 0.05) of this penalty range. Starting from the best radial (e.g., the point on the TA ring representing an optimal candidate geolocation), the components 114-122 can traverse left until the penalty difference reaches the accuracy threshold, defining the “left accuracy” as the arc length moved. Similarly, traversing right from the best radial until the penalty difference reaches the accuracy threshold defines the “right accuracy.” The raw accuracy is computed as the square root of the product of left and right accuracies. The final accuracy is then obtained by multiplying the raw accuracy by 2.0 and dividing by the number of RSRP predictors. The components 114-122 can assign confidence based on a confidence parameter that controls whether confidence is determined by absolute accuracy. This parameter may be set as default to False. If the confidence parameter is set to true, confidence levels are assigned as high, medium, or low based on specific accuracy thresholds. For example, responsive to an estimated accuracy of less than 200 meters (m), the components 114-122 can assign high confidence; responsive to an estimated accuracy greater than or equal to 200 m and less than 300 m, the components 114-122 can assign medium confidence; and responsive to an estimated accuracy greater than or equal to 300 m, the components 114-122 can assign low confidence. If the confidence parameter is set to false, confidence levels are assigned based on a fraction of the inter-site distance (ISD), with similar thresholds applied. For example, responsive to an estimated accuracy of <0.2*ISD, the components 114-122 can assign high confidence; responsive to an estimated accuracy greater than or equal to 0.2*ISD and less than 0.3*ISD, the components 114-122 can assign medium confidence; and responsive to an estimated accuracy greater than or equal to 0.3*ISD, the components 114-122 can assign low confidence.

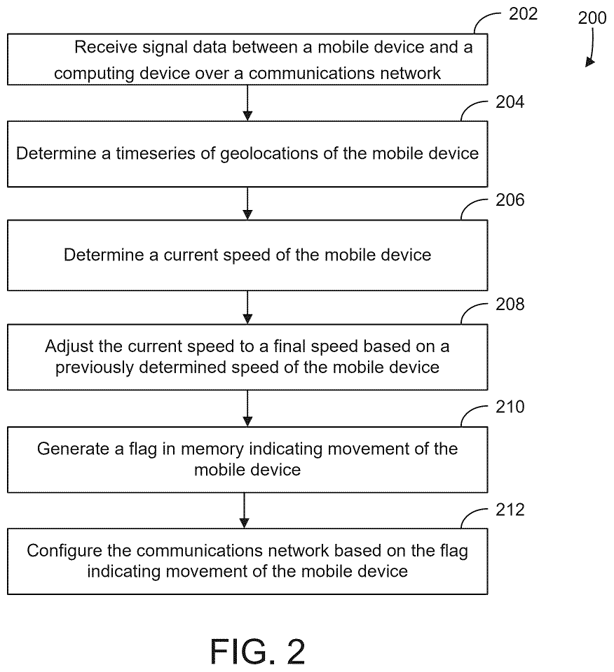

FIG. 2 is an example method 200 for performing geolocation processing using a ring search method, in accordance with an implementation. One or more operations of the method 200 can be performed by all or any combination or permutation of the components of the system 100, shown and described with reference to FIG. 1, such as the data processing system 102. The operations of the method 200 may be performed with more or fewer operations. Implementing method 200 enables more accurate and dynamic determination of device movement and location, allowing the communications network to optimize resource allocation, enhance signal quality, and improve overall network performance in real time.

At an operation 202, the data processing system 102 receives signal data between a mobile device and a computing device over a communications network. The signal data can include a plurality of sets of signal data each generated at a different time. Signal data can include control plane data, which can include timing advance (TA), beamforming information or index (BI), and radio frequency (RF) measurements measured by the UE, such as reference signal received power (RSRP), and reference signal received quality (RSRQ). The TA can be used for synchronization between the mobile device and the network and can be used to calculate the distance between a mobile device such as client device 104 and a cell tower.

At an operation 204, the data processing system 102 determines a timeseries of geolocations of the mobile device by analyzing the signal data to obtain geolocation information and their corresponding timestamps. The system can then determine time intervals useful for determining a speed of the mobile device.

At operation 206, the data processing system 102 determines the current speed of the mobile device. The system can compute a current speed of the mobile device by determining a difference between the current location and the previous location, then dividing the difference by an elapsed time, wherein the elapsed time is the time interval between the timestamp associated with the current location and the timestamp associated with the previous location. The data processing system 102 can adjust the current location by TA quantization and radial quantization, and can retrieve the previous location and time from metadata associated with stored signal data in a database.

At operation 208, the data processing system 102 adjusts the current speed to a final speed based on a previously determined speed of the mobile device. The previously determined speed may be obtained from metadata associated with stored signal data in the database. Responsive to a minimum time interval of three seconds elapsing, the data processing system 102 performs a weighted averaging of the current speed and the previously determined speed. The weight of the last speed can decrease exponentially over time to ensure that recent speed measurements have a greater influence on the final speed estimation. This approach accounts for the historical status of the mobile device, providing a more accurate and reliable speed calculation. If the minimum time interval of three seconds is not reached, the previously determined speed can be used as the final speed.

At operation 210, the data processing system 102 compares the final speed of the mobile device with a predefined speed threshold (e.g., 1.5 m/s). If the speed exceeds this threshold, a flag indicating movement of the mobile device is assigned as True; otherwise, it is assigned as False. This flag can be generated for each geolocation event associated with the signal data (e.g., a call start, call end, or fragment end) of the mobile device.

At operation 212, the data processing system configures the communications network based on the flag in memory indicating the movement of the mobile device. This configuration may involve dynamically adjusting the positions of antennas to ensure optimal signal strength and coverage. By realigning antennas, the system can reduce interference and enhance the overall performance of the network.

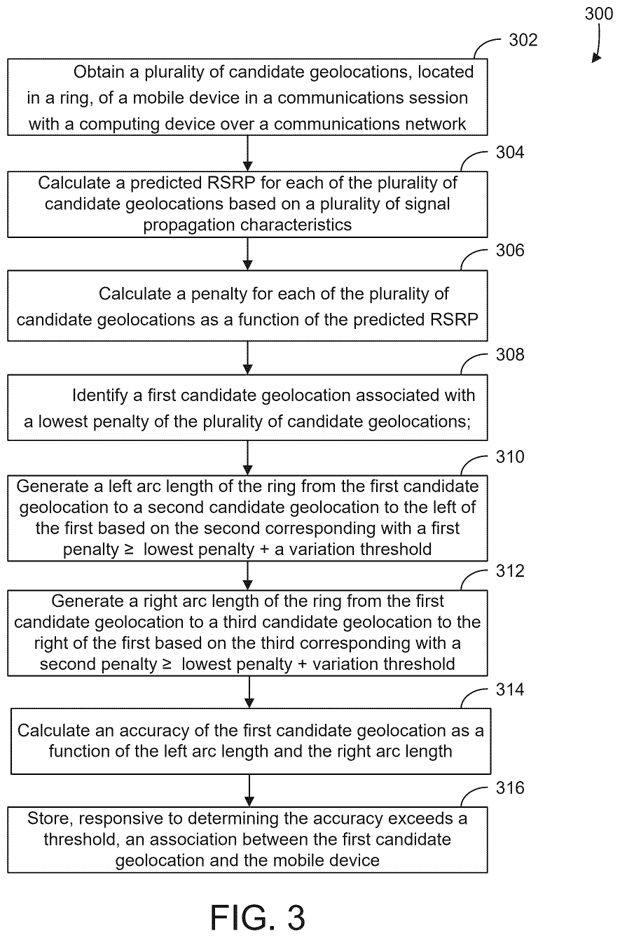

FIG. 3 is an example method 300 for performing geolocation processing using a ring search method, in accordance with an implementation. The method 300 can involve determining an association between a first candidate location from a plurality of candidate geolocations and a mobile device, such as client device 104. One or more operations of the method 300 can be performed by all or any combination or permutation of the components of the system 100, shown and described with reference to FIG. 1, such as the data processing system 102. The operations of the method 300 may be performed with more or fewer operations. Performing the method 300 can reduce computational overhead and improve geolocation accuracy by systematically narrowing the search space to candidate geolocations exhibiting penalty characteristics within a defined variation threshold, thereby enabling the data processing system 102 to allocate network resources more efficiently and minimize latency in real-time location-based services.

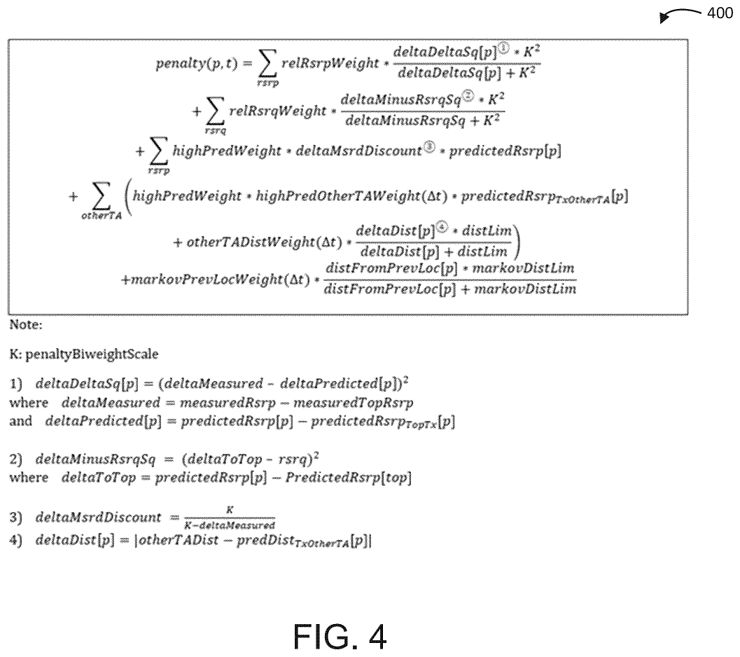

At an operation 302, the data processing system 102 obtains a plurality of candidate geolocations, located in a ring around a cell (e.g., a ring of a defined distance from the cell) of the communications network, of a mobile device in a communications session with the cell of the communications network. The data processing system 102 can evaluate available network data such as signal data for a plurality of candidate locations. Network data can also include location, azimuth, and radio frequency (RF) parameters for serving cells and neighbor cells. The plurality of candidate locations can include some or all of the candidate locations in the search space. The signal data can include control plane data such as timing advance (TA), beamforming information or index (BI), and/or RF measurements like RSRP and RSRQ. The data processing system can assess the candidate locations using a penalty function (see, e.g., FIG. 4), wherein each location of the plurality of candidate locations is assigned a penalty value, and the location with the minimum penalty is selected, as described further herein. This approach ensures accurate geolocation by considering the plurality of candidate locations.

In an example, the data processing system 102 can obtain a plurality of candidate geolocations of a mobile device by defining a ring search space centered on a serving cell, where the ring search space is constrained by a timing advance (TA) value reported during a communications session (e.g., the TA value associated with signals of the communications session). For example, responsive to receiving a TA value of 20 TA units for a 5G New Radio (NR) communications session with a subcarrier spacing of 30 kHz, the data processing system 102 can calculate a TA-based distance of approximately 781 meters from the serving cell using the formula: distance=(TA×16×64×speed of light×Tc)/(2×2μ), where μ is the numerology index corresponding to the subcarrier spacing and Tc is the NR system unit time given by Tc=1/(480 kHz*4096) which corresponds to 0.509 nanoseconds. The data processing system 102 can discretize the ring by generating 72 candidate geolocations evenly distributed at 5-degree angular increments (or any other defined angle increment) around a 360-degree arc centered at a geographic coordinate of the serving cell, with each candidate geolocation positioned at the calculated TA-based distance from the serving cell.

In some implementations, the data processing system 102 can exclude candidate geolocations that fall within a predefined exclusion zone, such as a body of water or a geographic region outside a coverage area of the communications network, by filtering the plurality of candidate geolocations based on geographic boundary data stored in the database. The data processing system 102 can store each candidate geolocation as a coordinate pair in memory, associating each coordinate pair with a respective angular offset relative to a boresight azimuth of the serving cell.

At an operation 304, the data processing system 102 calculates a predicted RSRP for each of the plurality of candidate geolocations (e.g., each of the non-filtered candidate geolocations). The data processing system 102 can do so, for example, by applying a propagation model, based on a plurality of signal propagation characteristics. For example, the data processing system 102 can employ a Hata model, which does not account for terrain or clutter and predicts path loss as a function of distance. The predicted RSRP can be calculated using the formula: predictedRsrp=Tx power+antennaMaxGain−txLoss−antennaDiscrimiation−predictedPathLoss. Through applying this model, the method 300 can ensure that the predicted RSRP is accurately determined based on signal propagation characteristics.

For example, the data processing system 102 can receive a timing advance (TA) value of 15 TA units from a 5G New Radio (NR) communications session operating with a subcarrier spacing of 30 kHz, corresponding to a numerology index μ of 1. The data processing system 102 can calculate a TA-based distance of approximately 586 meters from a serving cell using the formula: distance=(TA×16×64×speed of light×Tc)/(2×2^{μ}), where μ is the numerology index corresponding to the subcarrier spacing and Tc is the NR system unit time given by Tc=1/(480 kHz*4096) which corresponds to 0.509 nanoseconds. The data processing system 102 can obtain, from the database, network element parameters including a transmit power of 43 dBm, an antenna maximum gain of 18 dB, a transmit loss of 2 dB, a transmitter height of 30 meters, and a frequency of 2600 MHz for the serving cell. The data processing system 102 can select a first candidate geolocation of the plurality of candidate geolocations positioned at the calculated TA-based distance of 586 meters from the serving cell at an azimuth of 120 degrees relative to a boresight azimuth of 90 degrees. The data processing system 102 can calculate a predicted path loss of 132 dB for the first candidate geolocation by applying a Hata model using the transmitter height of 30 meters, the frequency of 2600 MHz, and the distance of 586 meters. The data processing system 102 can calculate an antenna discrimination of 2.7 dB by applying the formula antennaDiscrimination=3×(θ/θbeamwidth)\hat{ }2, where θ is the azimuth difference of 30 degrees (120 degrees minus 90 degrees) and θbeamwidth is a horizontal beamwidth of 65 degrees. The data processing system 102 can calculate a predicted RSRP of −75.7 dBm for the first candidate geolocation by applying the formula: predictedRsrp=Tx power+antennaMaxGain−txLoss−antennaDiscrimination-predictedPathLoss, yielding 43+18−2−2.7−132=−75.7 dBm.

At an operation 306, the data processing system 102 calculates a penalty for each of the plurality of candidate geolocations. The data processing system 102 can do so as a function of the predicted RSRP by assigning a penalty value to each candidate location based at least on the difference between the predicted and actual RSRP values (see, e.g., FIG. 4).

In some implementations, the data processing system 102 can determine a penalty range for the penalties calculated for the plurality of candidate geolocations. For instance, the data processing system 102 can identify a maximum penalty value and a minimum penalty value among the calculated penalties and compute a difference between the maximum penalty value and the minimum penalty value. The data processing system 102 can scan the plurality of candidate geolocations sequentially around the ring to identify the maximum penalty value and the minimum penalty value. For example, responsive to the data processing system 102 calculating penalties of 141, 139, 147, 146, and 145 for five candidate geolocations on the ring, the data processing system 102 can identify 139 as the minimum penalty value and 147 as the maximum penalty value, and can compute the penalty range as 8 by subtracting the minimum penalty value from the maximum penalty value. The data processing system 102 can store the penalty range in memory in association with a session identifier of the communications session.

In some implementations, the data processing system 102 can determine a variation threshold for the penalty range. The data processing system 102 can do so, for example, based at least on the penalty range. For instance, the data processing system 102 can apply a predefined scaling ratio to the penalty range. The data processing system 102 can retrieve the predefined scaling ratio from a configuration parameter stored in a database (e.g., the database 122). The predefined scaling ratio can be 0.05, for example. The data processing system 102 can calculate the variation threshold by multiplying the penalty range by the predefined scaling ratio. For example, responsive to the data processing system 102 determining a penalty range of 12 for a plurality of candidate geolocations distributed around a ring defined by a timing advance (TA) value, the data processing system 102 can calculate the variation threshold as 0.6 by multiplying 12 0.05. The data processing system 102 can store the calculated variation threshold in memory in association with a session identifier corresponding to the communications session between the mobile device and the computing device over the communications network.

At an operation 308, the data processing system 102 identifies a first candidate geolocation. The data processing system 102 can do so based on the first candidate geolocation being associated with the lowest penalty of the plurality of geolocations. For instance, the data processing system 102 can calculate a penalty for each candidate location based on the difference between the predicted and actual RSRP values or using the function illustrated in FIG. 4. The data processing system 102 can select the candidate location with the minimum penalty as a first candidate geolocation. The first candidate geolocation may be a best estimation of the location of the UE. By minimizing the penalty, the algorithm can ensure that the estimated location is as close as possible to the true location of the mobile device, thereby improving the overall accuracy and reliability of the geolocation process.

At an operation 310, the data processing system 102 generates a left arc length of the ring from the first candidate geolocation to a second candidate geolocation to the left of the first candidate geolocation. The operation 310 involves moving left from the point on the TA ring representing the first candidate geolocation until a point where the penalty difference between the second candidate and the first candidate reaches (e.g., exceeds or is at least) the variation threshold. This variation threshold is defined as a percentage of the penalty range across the ring. For example, the variation threshold may be 5% of the penalty range. The left arc length is defined as the distance moved along the ring to reach this point. This approach ensures that the geolocation accuracy is maintained by considering the penalty variations within the defined threshold.

In some implementations, the data processing system 102 can generate the left arc length by iteratively comparing penalties of a first sequence of the plurality of candidate geolocations to a sum of the lowest penalty and the variation threshold while moving to the left of the first candidate geolocation around the ring. The first sequence of candidate geolocations can be candidate geolocations to the left of the first candidate geolocation (e.g., in order based on distance from the first candidate geolocation). The data processing system 102 can select a candidate geolocation from the first sequence as a left boundary candidate geolocation responsive to determining that a penalty associated with the candidate geolocation exceeds or is equal to the sum of the lowest penalty and the variation threshold. The data processing system 102 can calculate the left arc length as an arc distance measured along the ring from the first candidate geolocation to the left boundary candidate geolocation.

For example, responsive to the data processing system 102 identifying a first candidate geolocation at an angular position of 120 degrees on a ring with a lowest penalty of 143 and a variation threshold of 3, the data processing system 102 can traverse candidate geolocations in the first sequence positioned at angular positions of 115 degrees, 110 degrees, and 105 degrees, calculating respective penalties of 144, 146, and 148. The data processing system 102 can determine that the penalty of 148 at the angular position of 105 degrees exceeds the sum of 143 plus 3, which equals 146, and can select the candidate geolocation at 105 degrees as the left boundary candidate geolocation. The data processing system 102 can calculate the left arc length as 15 degrees by subtracting 105 degrees from 120 degrees, or can convert the angular distance to a linear arc distance by multiplying 15 degrees by a radius of the ring.

At an operation 312, the data processing system 102 generates a right arc length of the ring from the first candidate geolocation to a third candidate geolocation to the right of the first, the method involves moving right from the point on the TA ring representing the first candidate geolocation until a point where the penalty difference between the third candidate and the first candidate reaches the variation threshold. This variation threshold is defined as a percentage of the penalty range across the ring. For example, the variation threshold may be 5% of the penalty range. The right arc length is defined as the distance moved along the ring to reach this point. This approach ensures that the geolocation accuracy is maintained by considering the penalty variations within the defined threshold.

In some implementations, the data processing system 102 can generate the right arc length by iteratively comparing penalties of a second sequence of the plurality of candidate geolocations to a sum of the lowest penalty and the variation threshold while moving to the right of the first candidate geolocation around the ring. The second sequence of candidate geolocations can be candidate geolocations to the right of the first candidate geolocation (e.g., in order based on distance from the first candidate geolocation). The data processing system 102 can select a candidate geolocation from the second sequence as a right boundary candidate geolocation responsive to determining that a penalty associated with the candidate geolocation exceeds the sum of the lowest penalty (e.g., of the second sequence) and the variation threshold. The data processing system 102 can calculate the right arc length as an arc distance measured along the ring from the first candidate geolocation to the right boundary candidate geolocation. For example, responsive to the data processing system 102 identifying a first candidate geolocation at an angular position of 120 degrees on a ring with a lowest penalty of 143 and a variation threshold of 3, the data processing system 102 can traverse candidate geolocations in the second sequence positioned at angular positions of 125 degrees, 130 degrees, and 135 degrees, calculating respective penalties of 144.5, 146, and 145. The data processing system 102 can determine that the penalty of 146 at the angular position of 130 degrees has reached (e.g., is equal to) the sum of 143 plus 3, which equals 143, and can select the candidate geolocation at 130 degrees as the right boundary candidate geolocation. The data processing system 102 can calculate the right arc length as 10 degrees by subtracting 120 degrees from 130 degrees, or can convert the angular distance to a linear arc distance by multiplying 10 degrees by a radius of the ring.

At an operation 314, the data processing system 102 calculates an accuracy of the first candidate geolocation as a function of the left arc length and the right arc length. The operation 314 involves calculating a raw accuracy as the square root of the product of the left and right arc lengths. The data processing system 102 can adjust the raw accuracy by a factor of 2.0 divided by the number of RSRP predictors to obtain the final accuracy. This approach ensures a precise estimation of the geolocation by considering the penalty variations within the defined threshold.

In some implementations, the data processing system 102 can adjust the accuracy to a final accuracy based on a number of Reference Signal Received Power (RSRP) predictors. The number of RSRP predictors can be a number of distinct signal propagation models or measurement sources used to generate predicted RSRP values for the plurality of candidate geolocations. The data processing system 102 can calculate a final accuracy by multiplying the raw accuracy value by a scaling factor of 2.0 and dividing the result by the count of RSRP predictors. For example, responsive to the data processing system 102 calculating a left arc length of 150 meters and a right arc length of 200 meters for a first candidate geolocation on a ring defined by a timing advance (TA) value, the data processing system 102 can calculate the raw accuracy value as the square root of 30,000 (e.g., 150*200) square meters, which equals approximately 173.2 meters. The data processing system 102 can retrieve a count of three RSRP predictors from the database, where the three RSRP predictors correspond to a serving cell and two neighbor cells that provided measurements for the calculations. The data processing system 102 can calculate the final accuracy as (173.2 meters×2.0)/3, which equals approximately 115.5 meters, and can store the final accuracy in memory in association with the first candidate geolocation and a session identifier corresponding to the communications session between the mobile device and the data processing system over the communications network.

At an operation 316, the data processing system 102 stores an association between the first candidate geolocation and the mobile device by determining that the accuracy of the first candidate geolocation exceeds a predefined threshold. Responsive to determining the accuracy of the first candidate geolocation exceeds the predefined threshold, the data processing system 102 can store the association between the first candidate geolocation and the mobile device in memory, maintaining precise geolocation records.

In some implementations, the data processing system 102 can compare the calculated accuracy of the first candidate geolocation to a plurality of confidence thresholds stored in memory to determine a confidence level for the first candidate geolocation. The data processing system 102 can retrieve the plurality of confidence thresholds from a configuration parameter in the database, where the plurality of confidence thresholds can include a high confidence threshold, a medium confidence threshold, and a low confidence threshold. For example, responsive to the data processing system 102 calculating an accuracy of 180 meters for a first candidate geolocation on a ring defined by a timing advance (TA) value, the data processing system 102 can retrieve a high confidence threshold of 200 meters, a medium confidence threshold of 300 meters, and a low confidence threshold of 500 meters from the database. The data processing system 102 can determine that the calculated accuracy of 180 meters is less than the high confidence threshold of 200 meters, and can assign a high confidence level to the first candidate geolocation. The data processing system 102 can store the association between the first candidate geolocation and the mobile device, in some cases, with the determined confidence level, in memory responsive to determining that the confidence level is high. In some implementations, the data processing system 102 can generate an alert responsive to determining the confidence level is not high enough (e.g., is not above at least one defined threshold of the plurality of thresholds). In such cases, the data processing system 102 may not use the determined geolocation for further functions because there is a high likelihood of the geolocation being incorrect.

In some implementations, the data processing system 102 can adjust the communications network 105. The data processing system can do so based on the determined first candidate geolocation of the mobile device. For example, the data processing system can modify antenna orientations of one or more of the cells that detected or received signals from the mobile device based on the stored association between the first candidate geolocation and the mobile device. The data processing system 102 can retrieve the stored association from memory, extract a geographic coordinate pair corresponding to the first candidate geolocation, and determine a signal propagation path from one or more of the cell to the first candidate geolocation. The data processing system 102 can calculate an azimuth angle for one or more antennas of the serving cell by applying a beam-steering function that maximizes predicted signal strength at the first candidate geolocation while minimizing interference to neighboring cells. The data processing system 102 can generate a control signal encoding the calculated azimuth angle and transmit the control signal to a motorized actuator coupled to the one or more antennas (e.g., via the network interface 108).

For example, responsive to the data processing system 102 determining that the first candidate geolocation is positioned at 42.3601° north latitude and 71.0589° west longitude at a distance of 2,500 meters from a serving cell located at 42.3456° north latitude and 71.0987° west longitude, the data processing system 102 can calculate a target azimuth of 135 degrees relative to true north, generate a control signal encoding the target azimuth, and transmit the control signal to a motorized actuator to rotate a directional antenna of the serving cell from an initial azimuth of 90 degrees to the target azimuth of 135 degrees, thereby aligning a main lobe of an antenna radiation pattern toward the first candidate geolocation.

In some implementations, the data processing system 102 can adjust the communications network by transmitting the stored association between the first candidate geolocation and the mobile device to a self-organizing network controller of the communications network. The data processing system 102 can retrieve the stored association from memory and generate a geolocation message encoding the first candidate geolocation as a coordinate pair and a device identifier corresponding to the mobile device. The data processing system 102 can transmit the geolocation message to the self-organizing network controller via a network interface. The self-organizing network controller can apply a machine learning model to the geolocation message to determine one or more network adjustments based on the first candidate geolocation. For example, the self-organizing network controller can calculate an optimal antenna azimuth for one or more cells of the communications network by applying the machine learning model to a dataset including the first candidate geolocation, a plurality of historical geolocations of the mobile device, and a plurality of signal quality metrics associated with the communications session. The self-organizing network controller can generate a control signal encoding the calculated optimal antenna azimuth and transmit the control signal to a motorized actuator coupled to an antenna of a serving cell to rotate the antenna from an initial azimuth to the optimal antenna azimuth. The self-organizing network controller can adjust one or more transmission power levels of the serving cell and/or one or more neighbor cells based on the first candidate geolocation by applying the machine learning model to determine a power allocation that minimizes interference to neighboring cells while maintaining a signal-to-noise ratio above a threshold value at the first candidate geolocation.

Implementing method 300 offers several technical advantages for geolocating mobile devices within a communications network. By calculating predicted reference signal received power (RSRP) for multiple candidate geolocations and applying a penalty-based selection process, the method enhances the accuracy and reliability of determining a device's position. The use of arc length calculations and variation thresholds allows for dynamic adjustment of accuracy, ensuring that only high-confidence associations between geolocations and devices are stored. Additionally, integrating movement and environment detection based on signal data enables adaptive network configuration, optimizing both connectivity and resource allocation for mobile users.

FIG. 4 is an example penalty function 400 for determining a penalty associated with a geolocation, in accordance with an implementation. The geolocation can be a candidate geolocation of the plurality of candidate geolocations for estimating the location of a mobile device. A penalty can be determined for each candidate location in the search space based on associated signal data.

In an example, for a call with 1 TA and 2 neighbor rsrps. (no neighbor TA, no historical locations, no MDT, etc), the “predicted rsrps” are calculated based on the following configuration: 2 neighbor rsrp cells, [distance_to_serving_cell, relative_azimuth_to_serving_cell, borsight angle]=[300, 60.0, 240.0], [600, 240.0, 70.0], range=150, each point on this ring with radius=150 get its predicted rsrp calculated. RReal rsrps” are calculated based on neighbor cell configuration and ue location. ue has a 90 azimuth relative to serving cell (distance=150 according to the range). In this example, penalties may only be due to discrepancy between “predicted rsrps” and “real rsrps”, since serving TA doesn't impose any bias on points on the ring. The penalties are in the table below:

| Point Around Ring | Penalty |
|---|---|
| 0 | 148.432702 |
| 1 | 147.783125 |
| 2 | 147.063817 |
| 3 | 146.322494 |
| 4 | 145.485734 |
| 5 | 144.654451 |
| 6 | 143.813908 |
| 7 | 143.035334 |
| 8 | 142.350504 |
| 9 | 141.791734 |
| 10 | 141.353411 |
| 11 | 141.047985 |
| 12 | 140.864919 |
| 13 | 140.805876 |
| 14 | 140.874686 |
| 15 | 141.092787 |
| 16 | 141.430039 |
| 17 | 141.91219 |
| 18 | 142.500391 |
| 19 | 143.191898 |
| 20 | 143.877467 |

In another example, for a call with 1 serving TA and 1 neighbor TA. (no rsrps, no historical locations, no MDT, etc). “predicted dists” are calculated based on the following configuration: 1 neighbor TA cell, [distance_to_serving_cell, relative_azimuth_to_serving_cell, borsight angle]=[300, 45.0, 225.0], range=150, each point on this ring with radius=150 get its predicted dist calculated. “real dist” is calculated based on neighbor cell configuration and ue location. ue has a 45 azimuth relative to serving cell (distance=150 according to the range). In this example, penalties are only due to discrepancy between “predicted dists” and “real dist.” The penalties are in the table below:

| Point Around Ring | Penalty |
|---|---|
| 0 | 5.527843 |
| 1 | 5.487926 |
| 2 | 5.447199 |
| 3 | 5.409625 |
| 4 | 5.369002 |
| 5 | 5.333525 |
| 6 | 5.301065 |
| 7 | 5.277138 |
| 8 | 5.263392 |
| 9 | 5.254277 |
| 10 | 5.263392 |
| 11 | 5.277138 |
| 12 | 5.301065 |
| 13 | 5.333525 |
| 14 | 5.369002 |
| 15 | 5.409625 |
| 16 | 5.447199 |
| 17 | 5.487926 |
| 18 | 5.527843 |
| 19 | 5.570425 |
| 20 | 5.608671 |

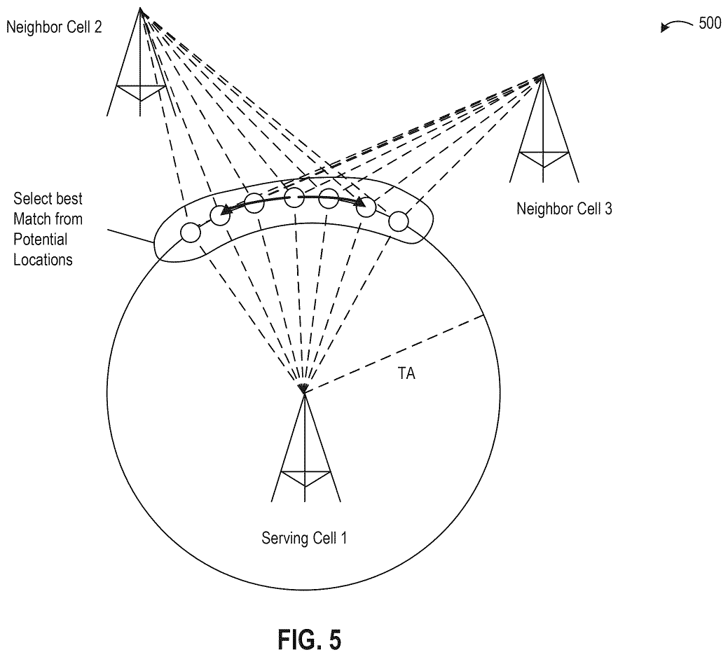

Referring now to FIG. 5, illustrated is a relative signal metric (RSM) geolocation algorithm that a system 500 can perform, in accordance with an implementation. The data processing system 102 can do so for a serving cell 1, a neighbor cell 2, and a neighbor cell 3 within the system 500. The data processing system 102 can determine a plurality of potential locations, visualized as points along a timing advance (TA) ring, around the serving cell 1. For example, the plurality of locations can include 72 locations on the TA ring. The system 500 can use TA to predict the distance between the potential location and the serving cell. The system 500 can be configured to build a scoring function and pick the best location out of the plurality of locations using the systems and methods described herein based on: RSRP from a serving cell (e.g., Serving Cell 1) and RSRP from neighbor cells (e.g., Neighbor Cells 2 and 3), antenna horizontal beam shape, and recent history of UE locations and associated timestamps. The system 500 can be configured to achieve a target median accuracy of a fraction of the inter-cell-site distance, for example, an eighth of the inter-cell-site distance.

At least one aspect relates to a system. The system can obtain a plurality of candidate geolocations of a mobile device participating in a communications session with a computing device over a communications network, wherein the plurality of candidate geolocations are located in a ring around a cell of the communications network. The system can calculate a predicted reference signal received power (RSRP) for each of the plurality of candidate geolocations based on a plurality of signal propagation characteristics associated with each of the plurality of candidate geolocations. The system can calculate a penalty for each of the plurality of candidate geolocations as a function of the predicted RSRP calculated for the candidate geolocation. The system can identify a first candidate geolocation that is associated with a lowest penalty of the plurality of candidate geolocations. The system can generate a left arc length of the ring from the first candidate geolocation to a second candidate geolocation selected from a first sequence of the plurality of candidate geolocations to the left of the first candidate geolocation based on the second candidate geolocation corresponding with a first penalty greater than or equal to the lowest penalty plus a variation threshold. The system can generate a right arc length of the ring from the first candidate geolocation to a third candidate geolocation selected from a second sequence of the plurality of candidate geolocations to the right of the first candidate geolocation based on the third candidate geolocation corresponding with a second penalty greater than or equal to the lowest penalty plus the variation threshold. The system can calculate an accuracy of the first candidate geolocation as a function of the left arc length and the right arc length. The system can store, responsive to determining the accuracy exceeds a threshold, an association between the first candidate geolocation and the mobile device.

In some implementations, the system can adjust the communications network based on the stored association between the first candidate geolocation and the mobile device. In some implementations, the system can generate the left arc length by iteratively comparing penalties of the first sequence of the plurality of candidate geolocations to a sum of the lowest penalty and the variation threshold moving to the left of the first candidate geolocation around the ring. In some implementations, the system can generate the right arc length by iteratively comparing penalties of the second sequence of the plurality of candidate geolocations to a sum of the lowest penalty and the variation threshold moving to the right of the first candidate geolocation around the ring.

In some implementations, the system can determine a penalty range of the ring based on the calculated penalties for the plurality of candidate geolocations. In some implementations, the system can determine the left arc length and the right arc length based further on the penalty range. In some implementations, the system can determine the variation threshold based at least on the penalty range.

In some implementations, the system can adjust the accuracy to a final accuracy based on a number of Reference Signal Received Power (RSRP) predictors. In some implementations, the system can compare the accuracies to a plurality of thresholds to determine a confidence for the first candidate geolocation. In some implementations, the system can store the association responsive to determining the confidence is high.

At least one other aspect relates to a method. The method can be performed, for example, by one or more processors coupled to non-transitory memory. The method can include obtaining a plurality of candidate geolocations of a mobile device participating in a communications session with a computing device over a communications network, wherein the plurality of candidate geolocations are located in a ring around a cell of the communications network. The method can include calculating a predicted reference signal received power (RSRP) for each of the plurality of candidate geolocations based on a plurality of signal propagation characteristics associated with each of the plurality of candidate geolocations. The method can include calculating a penalty for each of the plurality of candidate geolocations as a function of the predicted RSRP calculated for the candidate geolocation. The method can include identifying a first candidate geolocation that is associated with a lowest penalty of the plurality of candidate geolocations. The method can include generating a left arc length of the ring from the first candidate geolocation to a second candidate geolocation selected from a first sequence of the plurality of candidate geolocations to the left of the first candidate geolocation based on the second candidate geolocation corresponding with a first penalty greater than or equal to the lowest penalty plus a variation threshold. The method can include generating a right arc length of the ring from the first candidate geolocation to a third candidate geolocation selected from a second sequence of the plurality of candidate geolocations to the right of the first candidate geolocation based on the third candidate geolocation corresponding with a second penalty greater than or equal to the lowest penalty plus the variation threshold. The method can include calculating an accuracy of the first candidate geolocation as a function of the left arc length and the right arc length. The method can include storing, responsive to determining the accuracy exceeds a threshold, an association between the first candidate geolocation and the mobile device.

In some implementations, generating the left arc length comprises iteratively comparing penalties of the first sequence of the plurality of candidate geolocations to sum of the lowest penalty and the variation threshold moving to the left of the first candidate geolocation around the ring. In some implementations, generating the right arc length comprises iteratively comparing penalties of the second sequence of the plurality of candidate geolocations to sum of the lowest penalty and the variation threshold moving to the right of the first candidate geolocation around the ring.

In some implementations, the method can further include determining a penalty range of the ring based on the calculated penalties for the plurality of candidate geolocations. In some implementations, the method can further include determining the left arc length and the right arc length based further on the penalty range. In some implementations, the method can further include determining the variation threshold based at least on the penalty range.

At least one aspect relates to a system. The system can receive, from a plurality of cells, signal data for a communications session between a mobile device and computing device occurring over a communications network, the signal data comprising a plurality of sets of signal data each generated at a different time. The system can determine a timeseries of geolocations of the mobile device during the communications session based on the plurality of sets of signal data received for the communications session from the plurality of cells. The system can determine a current speed of the mobile device based on the timeseries of geolocations of the mobile device. The system can adjust the current speed to a final speed based on a previously determined speed of the mobile device. The system can generate, responsive to determining the final speed exceeds a threshold, a flag in memory indicating movement of the mobile device. The system can configure the communications network based on the flag indicating movement of the mobile device.

In some implementations, the system can determine the final speed by determining an average speed based on the current speed and the final speed. In some implementations, the system can determine the average speed by determining a weighted average speed based on the current speed and the final speed. In some implementations, the system can determine the weighted average speed by determining a weight of the weighted average speed as a function of a length of time between the current speed and the previously determined speed.

In some implementations, the system can generate a second flag in memory indicating an environment of the mobile device based on the flag in memory indicating movement of the mobile device and an amount of time. In some implementations, the system can determine an indoor or outdoor classification of the mobile device based at least on a Reference Signal Received Power (RSRP). In some implementations, the system can generate, as output, a geolocation of the mobile device based at least on the flag indicating movement, the second flag indicating an environment, and the indoor or outdoor classification.

FIG. 6A depicts an example network environment that can be used in connection with the methods and systems described herein. In brief overview, the network environment 600 includes one or more client devices 104 (also generally referred to as clients, client node, client machines, client computers, client computing devices, endpoints, or endpoint nodes) in communication with one or more servers 602 (also generally referred to as servers, nodes, or remote machine) via one or more networks 105. In some embodiments, a client 104 has the capacity to function as both a client node seeking access to resources provided by a server and as a server providing access to hosted resources for other client devices 104.

Although FIG. 6A shows a network 105 between the client devices 104 and the servers 602, the client devices 104 and the servers 602 can be on the same network 105. In embodiments, there are multiple networks 105 between the client devices 104 and the servers 602. The network 105 can include multiple networks such as a private network and a public network. The network 105 can include multiple private networks.

The network 105 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, NR and NR Advanced, Mobile WiMAX, and WiMAX-Advanced. Cellular network standards can use various channel access methods, e.g., FDMA, TDMA, CDMA, or SDMA. In some embodiments, different types of data can be transmitted via different links and standards. In other embodiments, the same types of data can be transmitted via different links and standards.

The network 105 can be any type and/or form of network. The geographical scope of the network 105 can vary widely and the network 105 can be a body area network (BAN), a personal area network (PAN), a local-area network (LAN), e.g., Intranet, a metropolitan area network (MAN), a wide area network (WAN), or the Internet. The topology of the network 105 can be of any form and can include, e.g., any of the following: point-to-point, bus, star, ring, mesh, or tree. The network 105 can be an overlay network which is virtual and sits on top of one or more layers of other networks 105. The network 105 can be of any such network topology as known to those ordinarily skilled in the art capable of supporting the operations described herein. The network 105 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 105 can be a type of a broadcast network, a telecommunications network, a data communication network, or a computer network.

The network environment 600 can include multiple, logically grouped servers 602. The logical group of servers can be referred to as a data center 608 (or server farm or machine farm). In embodiments, the servers 602 can be geographically dispersed. The data center 608 can be administered as a single entity or different entities. The data center 608 can include multiple data centers 608 that can be geographically dispersed. The servers 602 within each data center 608 can be homogeneous or heterogeneous (e.g., one or more of the servers 602 or machines 602 can operate according to one type of operating system platform (e.g., WINDOWS NT, manufactured by Microsoft Corp. of Redmond, Washington), while one or more of the other servers 602 can operate on according to another type of operating system platform (e.g., Unix, Linux, or Mac OS X)). The servers 602 of each data center 608 do not need to be physically proximate to another server 602 in the same machine farm 608. Thus, the group of servers 602 logically grouped as a data center 608 can be interconnected using a network. Management of the data center 608 can be de-centralized. For example, one or more servers 602 can comprise components, subsystems and modules to support one or more management services for the data center 608.

Server 602 can be a file server, application server, web server, proxy server, appliance, network appliance, gateway, gateway server, virtualization server, deployment server, SSL VPN server, or firewall. In embodiments, the server 602 can be referred to as a remote machine or a node. Multiple nodes can be in the path between any two communicating servers.

FIG. 6B illustrates an example cloud computing environment. A cloud computing environment 601 can provide client 104 with one or more resources provided by a network environment. The cloud computing environment 601 can include one or more client devices 104, in communication with the cloud 610 over one or more networks 105. Client devices 104 can include, e.g., thick clients, thin clients, and zero clients. A thick client can provide at least some functionality even when disconnected from the cloud 610 or servers 602. A thin client or a zero client can depend on the connection to the cloud 610 or server 602 to provide functionality. A zero client can depend on the cloud 610 or other networks 105 or servers 602 to retrieve operating system data for the client device. The cloud 610 can include back end platforms, e.g., servers 602, storage, server farms or data centers.

The cloud 610 can be public, private, or hybrid. Public clouds can include public servers 602 that are maintained by third parties to the client devices 104 or the owners of the clients. The servers 602 can be located off-site in remote geographical locations as disclosed above or otherwise. Public clouds can be connected to the servers 602 over a public network. Private clouds can include private servers 602 that are physically maintained by client devices 104 or owners of clients. Private clouds can be connected to the servers 602 over a private network 105. Hybrid clouds 608 can include both the private and public networks 105 and servers 602.

The cloud 610 can also include a cloud-based delivery, e.g., Software as a Service (Saas) 612, Platform as a Service (PaaS) 614, and the Infrastructure as a Service (IaaS) 616. IaaS can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, e.g., storage, networking, servers or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client devices 104 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 104 and server 602 can be deployed as and/or executed on any type and form of computing device, e.g., a computer, network device or appliance capable of communicating on any type and form of network and performing the operations described herein.

FIG. 6C depicts block diagrams of a computing device 603 useful for practicing an embodiment of the client 104 or a server 602. As shown in FIG. 6C, each computing device 603 can include a central processing unit 618, and a main memory unit 620. As shown in FIG. 6C, a computing device 603 can include one or more of a storage device 636, an installation device 632, a network interface 634, an I/O controller 622, a display device 630, a keyboard 624 or a pointing device 626, e.g., a mouse. The storage device 636 can include, without limitation, a program 640, such as an operating system, software, or software associated with system 100.

The central processing unit 618 is any logic circuitry that responds to and processes instructions fetched from the main memory unit 620. The central processing unit 618 can be provided by a microprocessor unit, e.g.: those manufactured by Intel Corporation of Mountain View, California. The computing device 603 can be based on any of these processors, or any other processor capable of operating as described herein. The central processing unit 618 can utilize instruction level parallelism, thread level parallelism, different levels of cache, and multi-core processors. A multi-core processor can include two or more processing units on a single computing component.

Main memory unit 620 can include one or more memory chips capable of storing data and allowing any storage location to be directly accessed by the microprocessor 618. Main memory unit 620 can be volatile and faster than storage 636 memory. Main memory units 620 can be Dynamic random-access memory (DRAM) or any variants, including static random-access memory (SRAM). The memory 620 or the storage 636 can be non-volatile; e.g., non-volatile read access memory (NVRAM). The memory 620 can be based on any type of memory chip, or any other available memory chips. In the example depicted in FIG. 6C, the processor 618 can communicate with memory 620 via a system bus 638.

A wide variety of I/O devices 628 can be present in the computing device 603. Input devices 628 can include keyboards, mice, trackpads, trackballs, touchpads, touch mice, multi-touch touchpads and touch mice, microphones, multi-array microphones, drawing tablets, cameras, or other sensors. Output devices can include video displays, graphical displays, speakers, headphones, or printers.

I/O devices 628 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 628, display devices 630 or group of devices can be augmented reality devices. The I/O devices can be controlled by an I/O controller 622 as shown in FIG. 6C. The I/O controller 622 can control one or more I/O devices, such as, e.g., a keyboard 624 and a pointing device 626, e.g., a mouse or optical pen. Furthermore, an I/O device can also provide storage and/or an installation device 632 for the computing device 603. In embodiments, the computing device 603 can provide USB connections (not shown) to receive handheld USB storage devices. In embodiments, an I/O device 628 can be a bridge between the system bus 638 and an external communication bus, e.g., a USB bus, a SCSI bus, a FireWire bus, an Ethernet bus, a Gigabit Ethernet bus, a Fibre Channel bus, or a Thunderbolt bus.

In embodiments, display devices 630 can be connected to I/O controller 622. Display devices can include, e.g., liquid crystal displays (LCD), electronic papers (e-ink) displays, flexile displays, light emitting diode displays (LED), or other types of displays. In some embodiments, display devices 630 or the corresponding I/O controllers 622 can be controlled through or have hardware support for OPENGL or DIRECTX API or other graphics libraries. Any of the I/O devices 628 and/or the I/O controller 622 can include any type and/or form of suitable hardware, software, or combination of hardware and software to support, enable or provide for the connection and use of one or more display devices 630 by the computing device 603. For example, the computing device 603 can include any type and/or form of video adapter, video card, driver, and/or library to interface, communicate, connect or otherwise use the display devices 630. In embodiments, a video adapter can include multiple connectors to interface to multiple display devices 630.

The computing device 603 can include a storage device 636 (e.g., one or more hard disk drives or redundant arrays of independent disks) for storing an operating system or other related software, and for storing application software programs 640 such as any program related to the systems, methods, components, modules, elements, or functions depicted in FIGS. 1-5. Examples of storage device 636 include, e.g., hard disk drive (HDD); optical drive including CD drive, DVD drive, or BLU-RAY drive; solid-state drive (SSD); USB flash drive; or any other device suitable for storing data. Storage devices 636 can include multiple volatile and non-volatile memories, including, e.g., solid state hybrid drives that combine hard disks with solid state cache. Storage devices 636 can be non-volatile, mutable, or read-only. Storage devices 636 can be internal and connect to the computing device 603 via a bus 638. Storage device 636 can be external and connect to the computing device 603 via an I/O device 630 that provides an external bus. Storage device 636 can connect to the computing device 603 via the network interface 634 over a network 105. Some client devices 104 may not require a non-volatile storage device 636 and can be thin clients or zero client devices 104. Some storage devices 636 can be used as an installation device 632 and can be suitable for installing software and programs.

The computing device 603 can include a network interface 634 to interface to the network 105 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The computing device 603 can communicate with other computing devices 603 via any type and/or form of gateway or tunneling protocol, e.g., Secure Socket Layer (SSL) or Transport Layer Security (TLS), QUIC protocol, or the Citrix Gateway Protocol manufactured by Citrix Systems, Inc. of Ft. Lauderdale, Florida. The network interface 634 can include a built-in network adapter, network interface card, PCMCIA network card, EXPRESSCARD network card, card bus network adapter, wireless network adapter, USB network adapter, modem or any other device suitable for interfacing the computing device 603 to any type of network capable of communication and performing the operations described herein.

A computing device 603 of the sort depicted in FIG. 6C can operate under the control of an operating system, which controls scheduling of tasks and access to system resources. The computing device 603 can be running any operating system configured for any type of computing device, including, for example, a desktop operating system, a mobile device operating system, a tablet operating system, or a smartphone operating system.

The computing device 603 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 603 has sufficient processor power and memory capacity to perform the operations described herein. In some embodiments, the computing device 603 can have different processors, operating systems, and input devices consistent with client device 104.

In embodiments, the status of one or more machines 104, 602 in the network 105 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 603 in response to the CPU 618 executing an arrangement of instructions contained in main memory 620. Such instructions can be read into main memory 620 from another computer-readable medium, such as the storage device 636. Execution of the arrangement of instructions contained in main memory 620 causes the computing device 603 to perform the illustrative processes described herein. One or more processors in a multi-processing arrangement may also be employed to execute the instructions contained in main memory 620. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system, comprising one or more processors configured by computer-readable instructions to:
obtain a plurality of candidate geolocations of a mobile device participating in a communications session with a computing device over a communications network, wherein the plurality of candidate geolocations are located in a ring around a cell of the communications network;
calculate a predicted reference signal received power (RSRP) for each of the plurality of candidate geolocations based on a plurality of signal propagation characteristics associated with each of the plurality of candidate geolocations;
calculate a penalty for each of the plurality of candidate geolocations as a function of the predicted RSRP calculated for the candidate geolocation;
identify a first candidate geolocation that is associated with a lowest penalty of the plurality of candidate geolocations;
generate a left arc length of the ring from the first candidate geolocation to a second candidate geolocation selected from a first sequence of the plurality of candidate geolocations to the left of the first candidate geolocation based on the second candidate geolocation corresponding with a first penalty greater than or equal to the lowest penalty plus a variation threshold;
generate a right arc length of the ring from the first candidate geolocation to a third candidate geolocation selected from a second sequence of the plurality of candidate geolocations to the right of the first candidate geolocation based on the third candidate geolocation corresponding with a second penalty greater than or equal to the lowest penalty plus the variation threshold;
calculate an accuracy of the first candidate geolocation as a function of the left arc length and the right arc length; and
store, responsive to determining the accuracy exceeds a threshold, an association between the first candidate geolocation and the mobile device.

2. The system of claim 1, wherein the one or more processors are further configured by computer-readable instructions to:
adjust the communications network based on the stored association between the first candidate geolocation and the mobile device.

3. The system of claim 1, wherein the one or more processors are configured by computer-readable instructions to:
generate the left arc length by iteratively comparing penalties of the first sequence of the plurality of candidate geolocations to a sum of the lowest penalty and the variation threshold moving to the left of the first candidate geolocation around the ring.

4. The system of claim 1, wherein the one or more processors are configured by computer-readable instructions to:
generate the right arc length by iteratively comparing penalties of the second sequence of the plurality of candidate geolocations to a sum of the lowest penalty and the variation threshold moving to the right of the first candidate geolocation around the ring.

5. The system of claim 1, wherein the one or more processors are further configured by computer-readable instructions to:
determine a penalty range of the ring based on the calculated penalties for the plurality of candidate geolocations; and
determine the left arc length and the right arc length based further on the penalty range.

6. The system of claim 5, wherein the one or more processors are further configured by computer-readable instructions to:
determine the variation threshold based at least on the penalty range.

7. The system of claim 1, wherein the one or more processors are further configured by computer-readable instructions to:
adjust the accuracy to a final accuracy based on a number of Reference Signal Received Power (RSRP) predictors.

8. The system of claim 1, wherein the one or more processors are further configured by computer-readable instructions to:
compare the accuracies to a plurality of thresholds to determine a confidence for the first candidate geolocation; and
store the association responsive to determining the confidence is high.

9. A method, comprising:
obtaining, by one or more processors, a plurality of candidate geolocations of a mobile device participating in a communications session with a computing device over a communications network, wherein the plurality of candidate geolocations are located in a ring around a cell of the communications network;
calculating, by the one or more processors, a predicted reference signal received power (RSRP) for each of the plurality of candidate geolocations based on a plurality of signal propagation characteristics associated with each of the plurality of candidate geolocations;
calculating, by the one or more processors, a penalty for each of the plurality of candidate geolocations as a function of the predicted RSRP calculated for the candidate geolocation;
identify a first candidate geolocation that is associated with a lowest penalty of the plurality of candidate geolocations;
generating, by the one or more processors, a left arc length of the ring from the first candidate geolocation to a second candidate geolocation selected from a first sequence of the plurality of candidate geolocations to the left of the first candidate geolocation based on the second candidate geolocation corresponding with a first penalty greater than or equal to the lowest penalty plus a variation threshold;
generating, by the one or more processors, a right arc length of the ring from the first candidate geolocation to a third candidate geolocation selected from a second sequence of the plurality of candidate geolocations to the right of the first candidate geolocation based on the third candidate geolocation corresponding with a second penalty greater than or equal to the lowest penalty plus the variation threshold;
calculating, by the one or more processors, an accuracy of the first candidate geolocation as a function of the left arc length and the right arc length; and
storing, by the one or more processors, responsive to determining the accuracy exceeds a threshold, an association between the first candidate geolocation and the mobile device.

10. The method of claim 9, wherein generating the left arc length comprises:
iteratively comparing by the one or more processors, penalties of the first sequence of the plurality of candidate geolocations to sum of the lowest penalty and the variation threshold moving to the left of the first candidate geolocation around the ring.

11. The method of claim 9, wherein generating the right arc length comprises:
iteratively comparing, by the one or more processors, penalties of the second sequence of the plurality of candidate geolocations to sum of the lowest penalty and the variation threshold moving to the right of the first candidate geolocation around the ring.

12. The method of claim 9, further comprising:
determining, by the one or more processors, a penalty range of the ring based on the calculated penalties for the plurality of candidate geolocations; and
determining, by the one or more processors, the left arc length and the right arc length based further on the penalty range.

13. The method of claim 12, further comprising:
determining, by the one or more processors, the variation threshold based at least on the penalty range.

14. A system, comprising one or more processors configured by computer-readable instructions to:
receive, from a plurality of cells, signal data for a communications session between a mobile device and computing device occurring over a communications network, the signal data comprising a plurality of sets of signal data each generated at a different time;
determine a timeseries of geolocations of the mobile device during the communications session based on the plurality of sets of signal data received for the communications session from the plurality of cells;
determine a current speed of the mobile device based on the timeseries of geolocations of the mobile device;
adjust the current speed to a final speed based on a previously determined speed of the mobile device;
generate, responsive to determining the final speed exceeds a threshold, a flag in memory indicating movement of the mobile device; and
configure the communications network based on the flag indicating movement of the mobile device.

15. The system of claim 14, wherein the one or more processors are configured by computer-readable instructions to determine the final speed by determining an average speed based on the current speed and the final speed.

16. The system of claim 15, wherein the one or more processors are configured by computer-readable instructions to determine the average speed by determining a weighted average speed based on the current speed and the final speed.

17. The system of claim 16, wherein the one or more processors are configured by computer-readable instructions to determine the weighted average speed by determining a weight of the weighted average speed as a function of a length of time between the current speed and the previously determined speed.

18. The system of claim 16, wherein the one or more processors are further configured by computer-readable instructions to generate a second flag in memory indicating an environment of the mobile device based on the flag in memory indicating movement of the mobile device and an amount of time.

19. The system of claim 18, wherein the one or more processors are further configured by computer-readable instructions to determine an indoor or outdoor classification of the mobile device based at least on a Reference Signal Received Power (RSRP).

20. The system of claim 19, wherein the one or more processors are further configured by computer-readable instructions to generate, as output, a geolocation of the mobile device based at least on the flag indicating movement, the second flag indicating an environment, and the indoor or outdoor classification.
